(19) United States
(12) Patent Application Publication
(10) Pub. No.: US 2004/0136774 A1
(43) Pub. Date: Jul. 15, 2004

(54) Notebook, folio, and divider with pen holder

(75) Inventor: Thomas Gerard O'Boyle, Charlotte, NC (US)

Correspondence Address: ADAM EVANS, P.A., (formerly Adams, Schwartz & Evans, P.A.), 2180 TWO WACHOVIA CENTER, CHARLOTTE, NC, 28282, US

(73) Assignee: TIMEPLANNER CALENDARS, INC., Charlotte, NC (US)

(21) Appl. No.: 10/703,308

(22) Filed: Nov. 7, 2003

Related U.S. Application Data
(60) Provisional application No. 60/439,118, filed on Jan. 10, 2003.

(51) Int. Cl. B42F 13/00

(52) U.S. Cl. 402/73

(57) ABSTRACT

A notebook, folio, and divider with an integrated writing instrument holder. The notebook and folio have a back cover that extends beyond a front cover and may have a plurality of sheets positioned between the front cover and back cover by at least a width of a writing instrument defining a support for the writing instrument holder. The writing instrument holder can be integrally-formed into the support or attached to the support by sewing stitches. The writing instrument holder is formed from a flexible material to allow adequate expansion for accommodating larger writing instruments. The back cover may also have a closure tab, with a writing instrument holder, integrally formed with the back cover for maintaining the notebook in a closed position.

This application claims the benefit of Provisional Application No. 60/439,118 filed on Jan. 10, 2003.

### TECHNICAL FIELD AND BACKGROUND OF THE INVENTION

This invention relates to a notebook, folio, or divider that includes a back cover that extends outwardly beyond a front cover and defines a support to which a writing instrument holder is attached. The holder provides a storage area in the notebook, folio, or divider for a pen or other writing instrument. The invention also relates to a notebook or folio that includes a closure tab and writing instrument holder for permitting the cover and pages of the notebook or folio to be maintained in a closed position when the notebook or folio is not in use.

Notebooks exist that provide means for closing the covers and positioning pens and other writing instruments on or in the notebooks. However, such notebooks fail to provide writing instrument holders capable of remaining attached to the notebook or folio after the pen or writing instrument has been repeatedly removed from and repositioned in the writing instrument holder. Furthermore, such notebooks fail to provide a cost-effective component that not only provides storage space for a pen or other writing instrument, but may also be simultaneously used to maintain the notebook in a closed position when the notebook is not in use.

The invention of the present application overcomes these disadvantages by providing embodiments of a notebook, a folio, and a divider, each of which includes a writing instrument holder, such as a pen loop, fastened to the notebook, folio, or divider. A notebook and a folio are also provided that each include an integrally-formed closure tab and writing instrument holder for permitting simultaneous writing instrument storage and a means of closing the notebook or folio when not in use. The divider can be used as a divider in a three ring binder or as a back cover for a spiral bond notebook, providing a writing instrument storage area for existing three ring binders and spiral bound notebooks.

### SUMMARY OF THE INVENTION

Therefore, it is an object of the invention to provide a notebook that includes a closure tab with an integrally-formed writing instrument holder.

It is another object of the invention to provide a folio that includes a closure tab that includes an integrally-formed writing instrument holder.

It is another object of the invention to provide a notebook that includes a closure tab for preventing the front cover, back cover and individual pages of the notebook from separating when the notebook is not in use.

It is another object of the invention to provide a folio that includes an integrally-formed writing instrument holder and closure tab for simultaneously preventing a pen or other writing instrument positioned within the writing instrument holder from becoming lost and maintaining the covers of the folio in a closed position when the folio is not in use.

It is another object of the invention to provide a notebook that includes an integrally-formed writing instrument holder and closure tab for simultaneously preventing a pen or other writing instrument positioned within the writing instrument holder from becoming lost and maintaining the covers of the folio in a closed position when the folio is not in use.

It is another object of the invention to provide a notebook having a closure tab that includes an integrally-formed writing instrument holder formed from the same material as the back cover and closure tab of the notebook.

It is another object of the invention to provide a notebook with writing instrument holder, such as a pen loop, for permitting a pen or other writing instrument to be stored within the notebook when the notebook is not in use.

It is another object of the invention to provide a divider with a writing instrument holder that can be added to an existing notebook or three ring binder.

These and other objects of the present invention are achieved in the preferred embodiments disclosed below by providing a notebook including a front cover and a back cover each having first and second major sides the back cover having a side edge that extends outwardly beyond a corresponding side edge of the front cover by at least a width of a writing instrument and defining a support for the writing instrument; a writing instrument holder for maintaining a writing instrument in position on the support; and connecting means for connecting the front cover and the back cover together.

According to another preferred embodiment of the invention, the notebook includes paper sheets having printed indicia thereon selected from the group consisting of calendar indicia, diary, text, photographs, and blank sheets for note taking.

According to another preferred embodiment of the invention, the front and back covers are formed from a sheet stock selected from the group consisting of plastic, cardboard, and fiberboard.

According to another preferred embodiment of the invention, the side edge of the back cover has a convex contour.

According to another preferred embodiment of the invention, the writing instrument holder includes a loop formed from a flexible material selected from the group consisting of plastic and elastic for providing adequate expansion to accommodate a writing instrument having a larger diameter than a diameter of the loop.

According to another preferred embodiment of the invention, the writing instrument holder is attached to the support using sewing stitches that extend through the holder and the back cover for preventing the holder from being pulled or otherwise removed from the back cover.

According to another preferred embodiment of the invention, the writing instrument holder is integrally-formed in the support of the back cover.

According to another preferred embodiment of the invention, the connecting means is selected from the group consisting of spiral binding and three ring binding for binding the sheets, the front cover, and the back cover loosely together.

According to another preferred embodiment of the invention, further including a closure tab integrally formed with and extending outwardly from the side edge of the back cover with the writing instrument holder for maintaining the writing instrument in an interior of the closure tab.

According to another preferred embodiment of the invention, the front cover includes a male fastener and the closure tab includes a female fastener acting in cooperation with each other for maintaining the notebook in a closed position.

According to another preferred embodiment of the invention, a folio including a single sheet of material folded to form a front cover and a back cover each having first and second major sides, the back cover having a side edge that extends outwardly beyond a corresponding side edge of the front cover by at least a width of a writing instrument; a writing instrument holder for maintaining a writing instrument in position on the support; and a closure tab formed with and extending outwardly from the side edge of the back cover.

According to another preferred embodiment of the invention, the front cover includes a male fastener and the closure tab includes a female fastener acting in cooperation with each other for maintaining the notebook in a closed position.

According to another preferred embodiment of the invention, the back cover includes an integrally-formed writing pad holder.

According to another preferred embodiment of the invention, the writing pad holder is attached against an inner surface of the back cover by at least one rivet.

According to another preferred embodiment of the invention, the writing pad holder includes an elongated slot for receiving a writing pad.

According to another preferred embodiment of the invention, a divider including a a sheet having a planar surface with first and second major sides, the sheet having a side edge that extends outwardly beyond a corresponding side edge of a sheet of paper by at least a width of a writing instrument to define a support for the writing instrument; a writing instrument holder for maintaining the writing instrument in position on the support; and connecting means for connecting the divider to a notebook.

According to another preferred embodiment of the invention, the sheet is formed from a sheet material selected from the group consisting of plastic, cardboard, and fiberboard.

According to another preferred embodiment of the invention, the writing instrument holder comprises a loop formed from a flexible material selected from the group consisting of plastic and elastic for providing adequate expansion to accommodate a writing instrument having a larger diameter than a diameter of the loop.

According to another preferred embodiment of the invention, the writing instrument holder is attached to the support by a means selected from the group of sewing stitches and integrally-formed with the back cover.

According to another preferred embodiment of the invention, the connecting means includes a plurality of holes positioned along the side edge for accepting spiral or three ring binding.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a front plan view of a notebook according to one preferred embodiment of the present invention;

FIG. 2 is a front plan view of a notebook according to FIG. 1 in an open position;

FIG. 3 is a front plan view of a notebook according to FIG. 1 and illustrating the manner in which a writing instrument is placed in the writing instrument holder;

FIG. 4 is a partial perspective view of the writing instrument holder of a notebook according to FIG. 1;

FIG. 5 is a rear plan view of a notebook according to FIG. 1;

FIG. 6 is a front plan view of a notebook according to an alternative embodiment of the invention;

FIG. 7 is a front plan view of a notebook according to FIG. 6 with the closure flap and notebook cover in an open position;

FIG. 8 is a partial perspective view of a notebook according to FIG. 6;

FIG. 9 is a partial perspective view of the writing instrument holder of the notebook shown in FIG. 8;

FIG. 10 is a front plan view of a notebook according to an alternative embodiment of the invention;

FIG. 11 is a front plan view of a notebook according to FIG. 10 and illustrating the manner in which a pad of paper is positioned in the notebook;

FIG. 12 is a rear plan view of a notebook according to FIG. 10 in the open position;

FIG. 13 is a plan view of a notebook back cover with a writing instrument holder;

FIG. 14 is a plan view of an alternative notebook back cover with a writing instrument holder;

FIG. 15 is a plan view of a notebook back cover secured in a three ring binder.

### DESCRIPTION OF THE PREFERRED EMBODIMENT AND BEST MODE

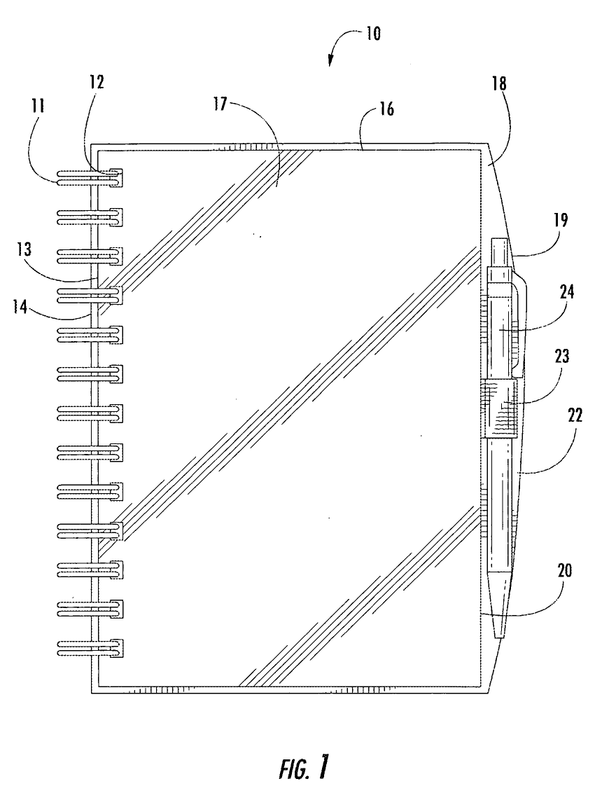

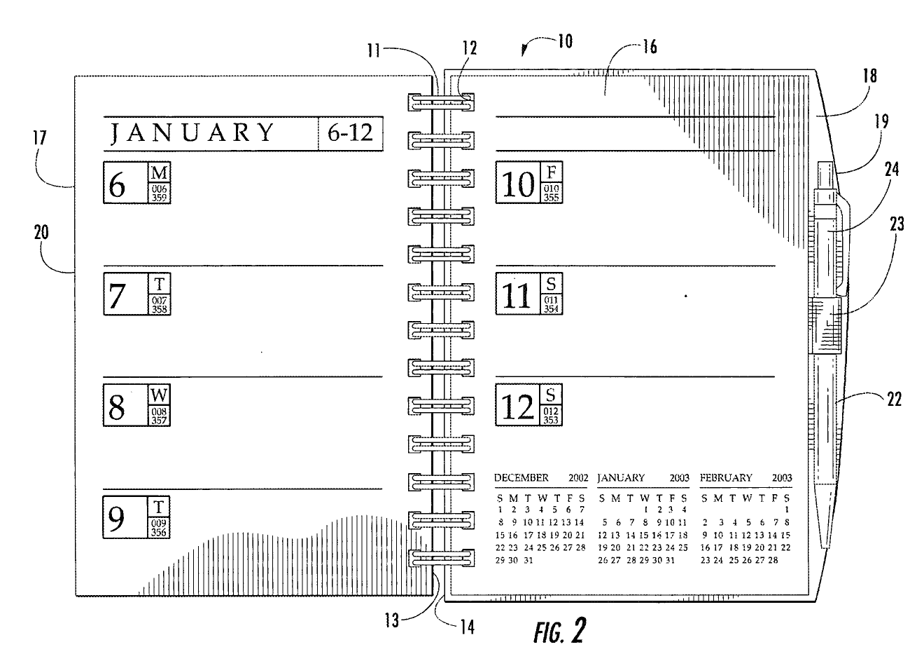

Referring now specifically to the drawings, a notebook 10 having first and second major sides according to the present invention is illustrated in FIGS. 1-3. A spiral binding 11 extends through holes 12 along a side edge 13 of a front cover 17 and a corresponding side edge 14 of a back cover 18. As is shown in FIG. 2, the notebook 10 may include a plurality of sheets 16 positioned between front 17 and back covers 18. The spiral binding 11 binds the front cover 17, sheets 16, and back cover 18 loosely together to permit the sheets 16 and covers 17 and 18 to be easily moved relative to the spiral binding 11 and to one another. Although the sheets 16 shown in FIG. 2 include calendar indicia printed thereon, the sheets 16 may alternatively include any other type of suitable printed indicia or photographs, or be left blank for note taking, journaling or recording other types of written indicia. The front 17 and back covers 18 are preferably formed from a semi-rigid sheet stock fabricated from a material such as plastic, cardboard or fiberboard. While the front cover 17, sheets 16, and back cover 18 of the notebook 10 shown in FIGS. 1 through 5 are bound together using a spiral binder 11, any suitable bookbinding system may be used, including a looseleaf ring binder with or without pages.

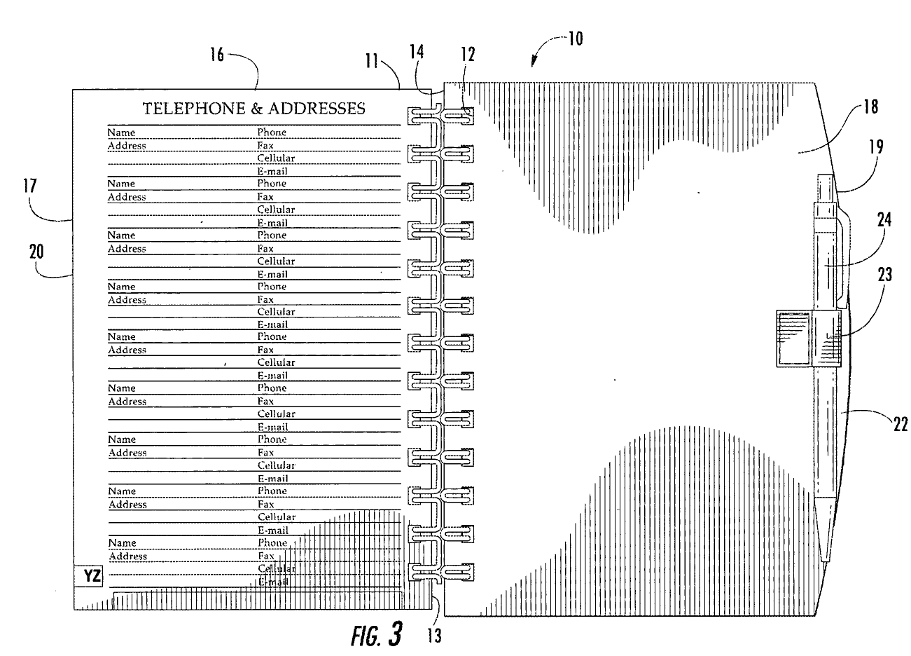

Referring now to FIG. 3, the back cover 18 includes a side edge 19 having a convex contour that extends outwardly away and beyond a corresponding side edge 20 of the front cover 17. This convex contour causes the width of the back cover 18 to be greater than that of the front cover 17, and defines a support 22 upon which a writing instrument holder 23 is mounted. A ballpoint pen 24 is shown positioned in the writing instrument holder 23; however, the writing instrument holder 23 may alternatively be used to hold any suitable writing instrument in place on the support 22 of the back cover 18. With the pen supported on the support 22, it is readily accessible for use and can be placed and removed without opening the notebook 10.

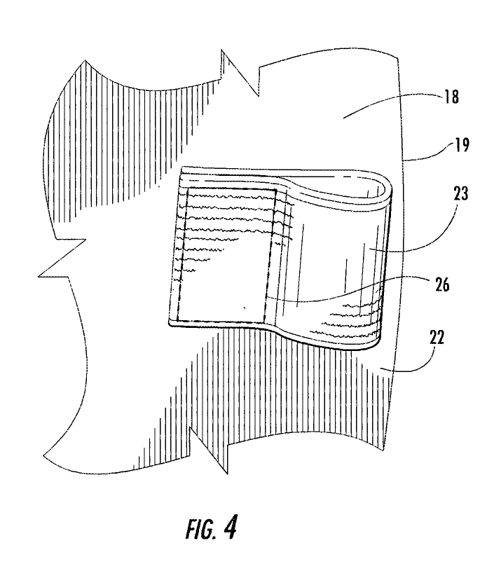

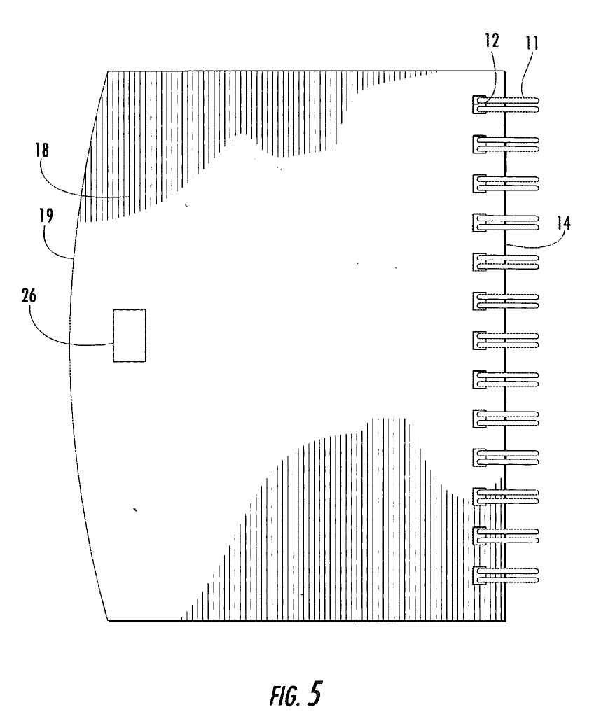

Referring now to FIG. 4, the structure of the writing instrument holder 23 is shown. The writing instrument holder 23 is preferably formed from a strip of elastic material. However, any other suitable flexible material may be used to allow adequate expansion to accommodate larger writing instruments. Although the strip of material from which the writing instrument holder 23 is formed may have any suitable dimensions, the strip preferably has a length of two inches and a width of ½ inch prior to being attached to the back cover 18. The writing instrument holder 23 is formed by joining the ends of the strip together and attaching the ends to the upper surface of the back cover 18. The writing instrument holder 23 is preferably attached to the back cover 18 using sewing stitches 26 that extend through not only the joined ends of the strip (see FIG. 4), but also the back cover 18 (see FIG. 5). Attaching the writing instrument holder 23 to the back cover 18 in this manner ensures that the ends of the writing instrument holder 23 stay conjoined and prevents the writing instrument holder 23 from being pulled or otherwise removed from the back cover 18.

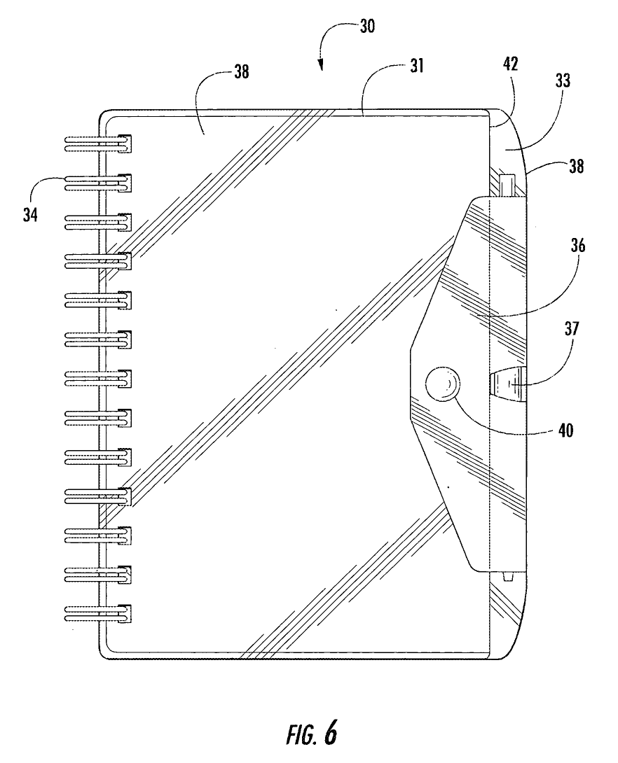

Referring now to FIG. 6, a notebook 30 according to another preferred embodiment of the invention is shown. Like the notebook 10 described above with reference to FIGS. 1 through 5, the notebook 30 shown in FIG. 6 may include a plurality of sheets 31 positioned between front 32 and back covers 33. The sheets 31, front cover 32, and back cover 33 are held together by a spiral binding 34. The spiral binding 34 is identical to that which is described above with reference to FIGS. 1 through 3. The back cover 33 includes a side edge 38 having a convex contour that extends outwardly away and beyond a corresponding side edge 42 of the front cover 32. As is shown in FIG. 6, the notebook 30 shown in FIG. 6 includes a closure tab 36 with an integrally-formed writing instrument holder 37. The writing instrument holder 37 may also be attached by sewing stitches as described in FIGS. 3-5. The tab 36 and integrally-formed writing instrument holder 37 permit a pen or other writing instrument to be stored in the interior of the closure tab 36 while simultaneously permitting the closure tab 36 to maintain the notebook 30 in a closed position when the notebook 30 is not in use.

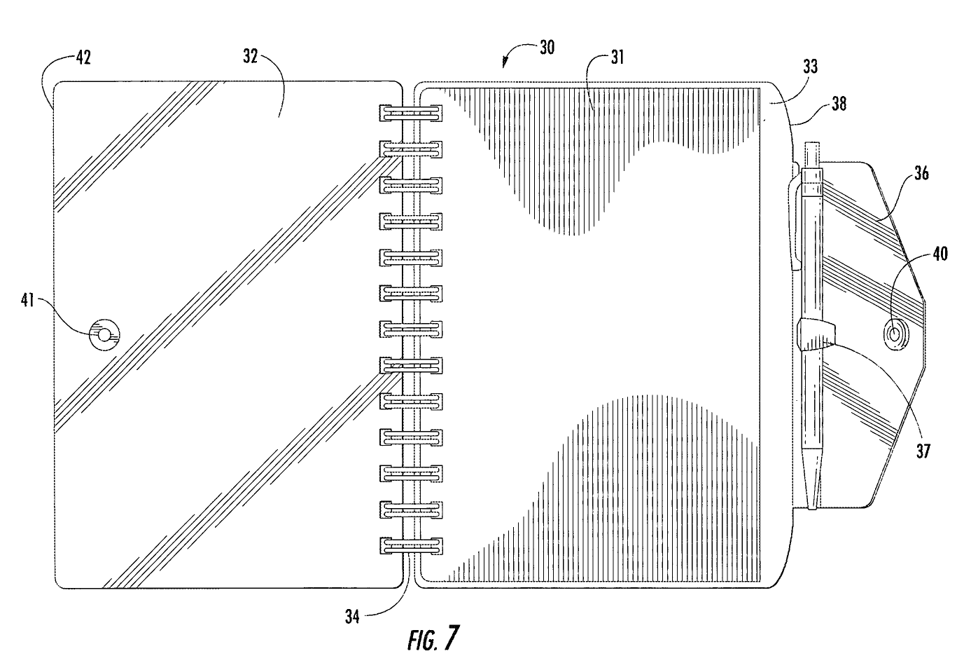

Referring now to FIG. 7, the closure tab 36 is integrally formed with and extends outwardly away from the side edge 38 of the back cover. The closure tab 36 includes a female snap fastener 40 that cooperates with a complementary male snap fastener 41 for maintaining the notebook 30 in the closed position (see FIG. 6). Referring again to FIG. 7, the male snap fastener 41 is positioned adjacent to the side edge 42 of the front cover.

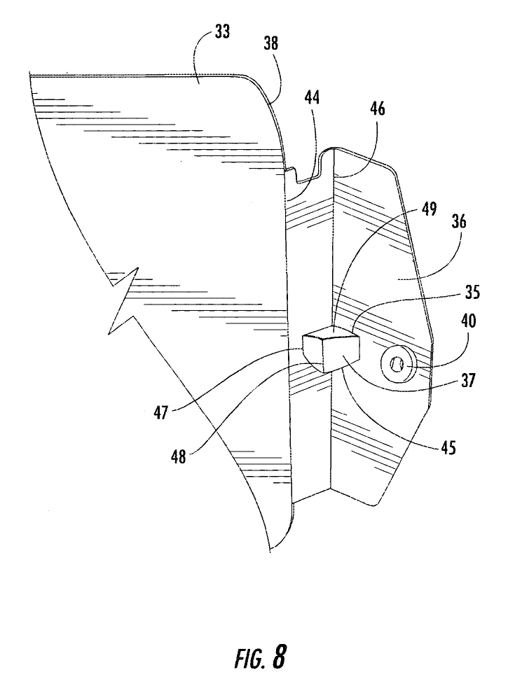

Referring now to FIG. 8, the closure tab 36 includes two folds 44 and 46 that extend parallel to each other and to the longitudinal axis of the spiral binding 34. The folds 44 and 46 form respective hinges for permitting the closure tab 36 to be folded around and positioned in closely-conforming configuration relative to the sheets of paper 31 and front cover 32 of the notebook 30. The notebook 30 is closed by positioning the male fastener 41 located on the front cover 32 within the female fastener 40 on the closure flap 36 (see FIG. 6).

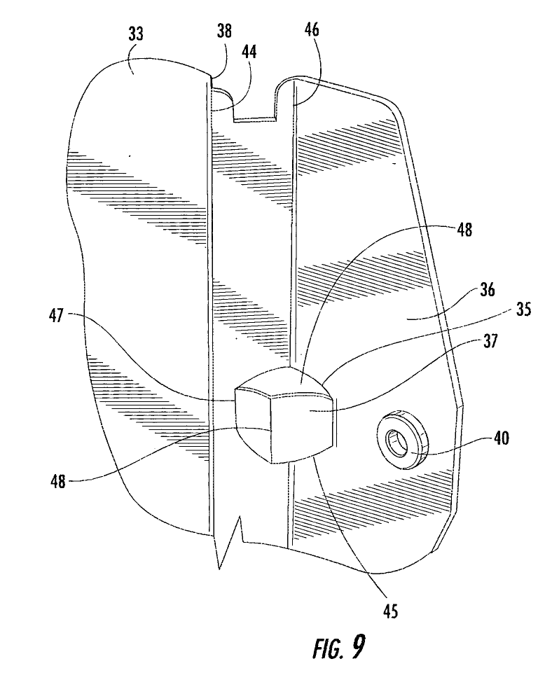

Referring now to FIG. 9, the closure tab 36 also includes an integrally-formed writing instrument holder 37. The writing instrument holder 37 includes a wall 47, formed by slits 35 and 45, having a fold 48 that extends outwardly away from the inner surface of the closure tab 36 at an inverse angle to that angle which is defined by the fold 48 located adjacent to the female snap fastener 40 on the closure tab 36. As is shown in FIG. 9, this inversely-angled wall 47 defines a passage 49 through which a pen or other writing instrument may be positioned. As is shown in FIG. 6, the location of the passage 49 relative to the closure flap 36 allows the writing instrument to extend through the passage 49 and be stored inside the tab 36 when the notebook 30 is not in use.

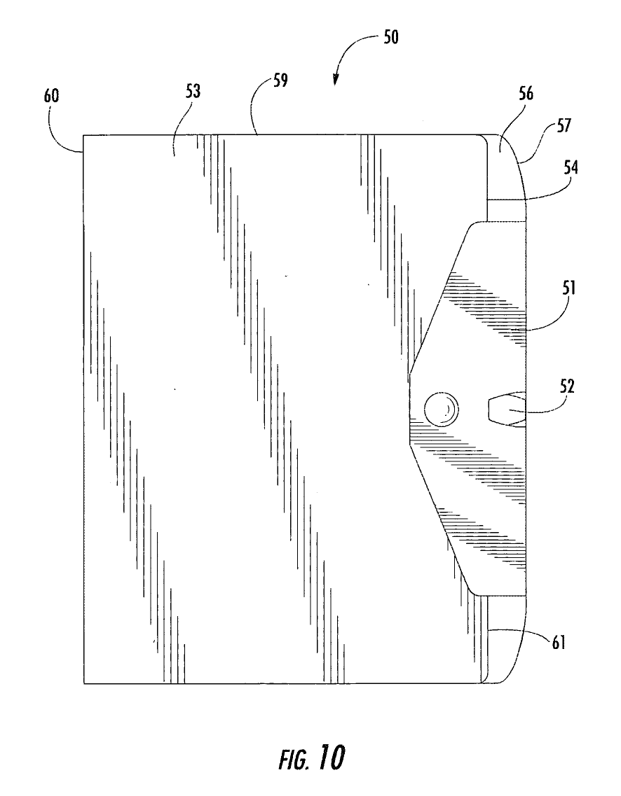

Referring now to FIG. 10, a folio 50 according to another preferred embodiment of the invention is shown. The folio 50 includes a closure tab 51 with an integrally-formed writing instrument holder 52 formed from the same materials and including the same components as the closure tab 36 and integrally-formed writing instrument holder 37 of the notebook 30 described above with reference to FIGS. 6 through 9.

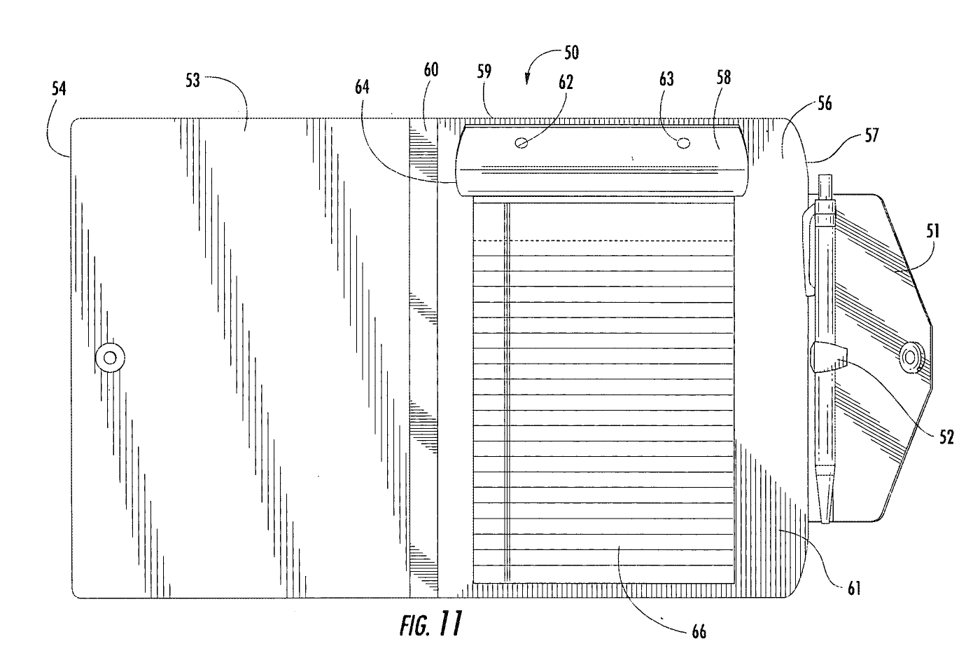

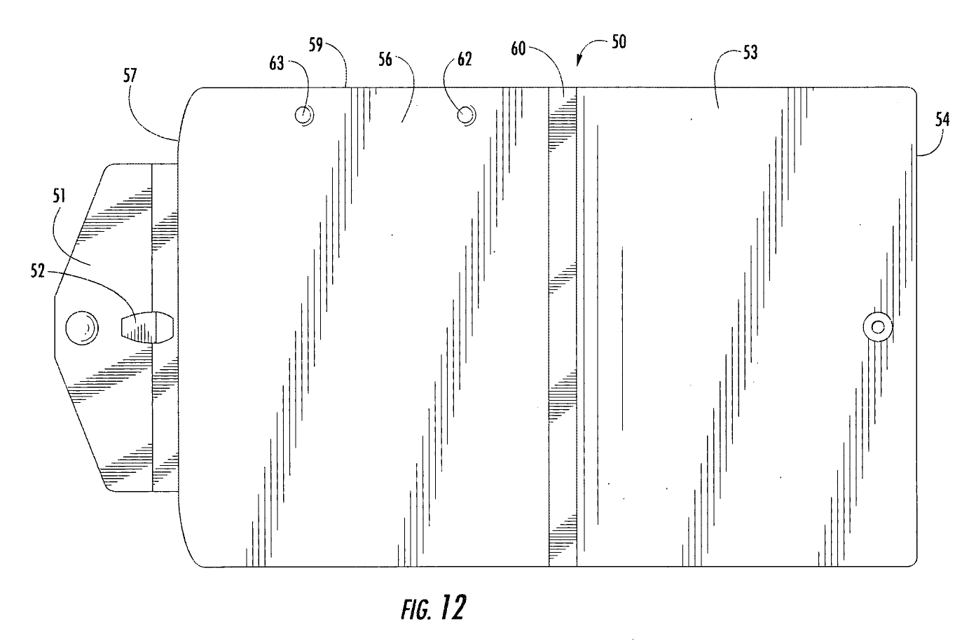

Referring now to FIGS. 11 and 12, the folio 50 is formed from a single sheet of material folded to form a front cover 53 and a back cover 56 each having first and second major sides. The back cover 56 includes a side edge 57 having a convex contour that extends outwardly away and beyond a corresponding side edge 54 of the front cover 53. The back cover 56 includes an integrally-formed writing pad holder 58 that is folded and extends over the inner surface 61 of the back cover 56 along an upper side edge 59 of the back cover 56 between the folded center 60 of the folio 50 and the closure tab 51. The writing pad holder 58 is held in place against the inner surface 61 of the back cover 56 by two rivets 62 and 63. The writing pad holder 58 includes an elongate slot 64 through which the back cover of a conventional writing pad 66 may be received.

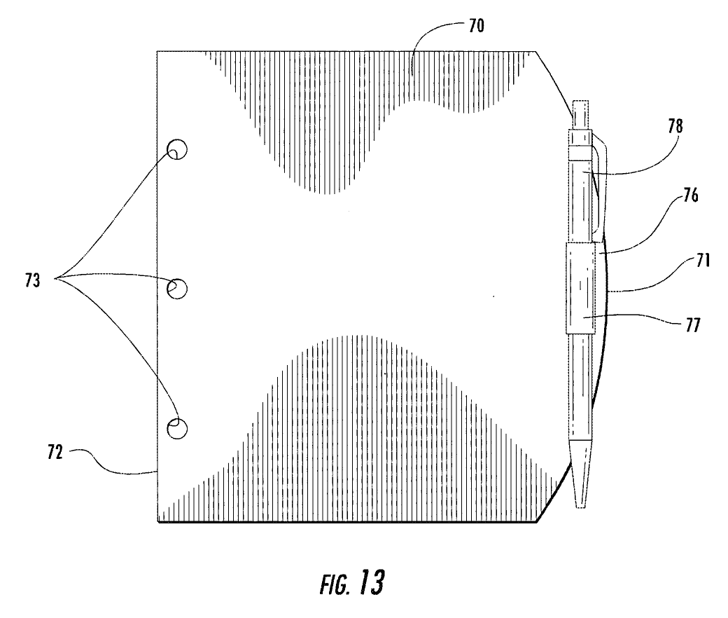

Referring now to FIGS. 13, 14, and 15, a divider 70 according to another preferred embodiment of the invention is shown. The divider 70 may be used as an add on for existing spiral bound notebooks or three ring binders. When used with three ring binders, the divider 70 can be used as a divider or a back providing a storage area in the three ring binder for a pen or other writing instrument.

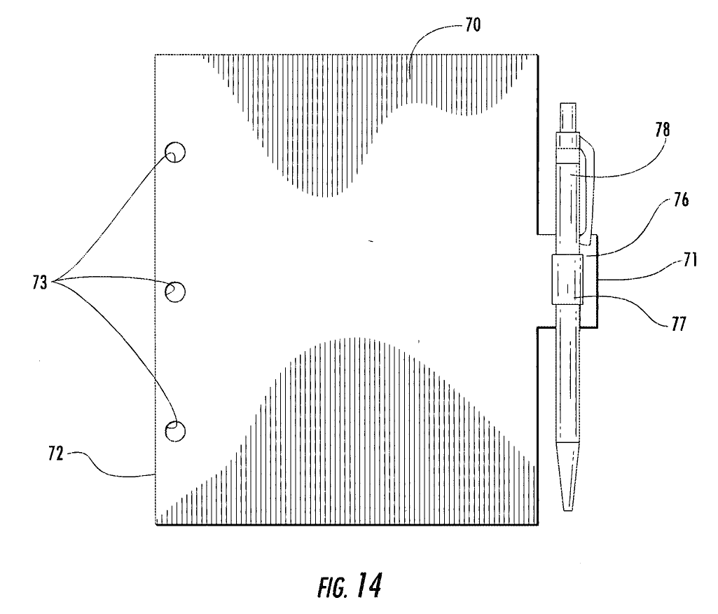

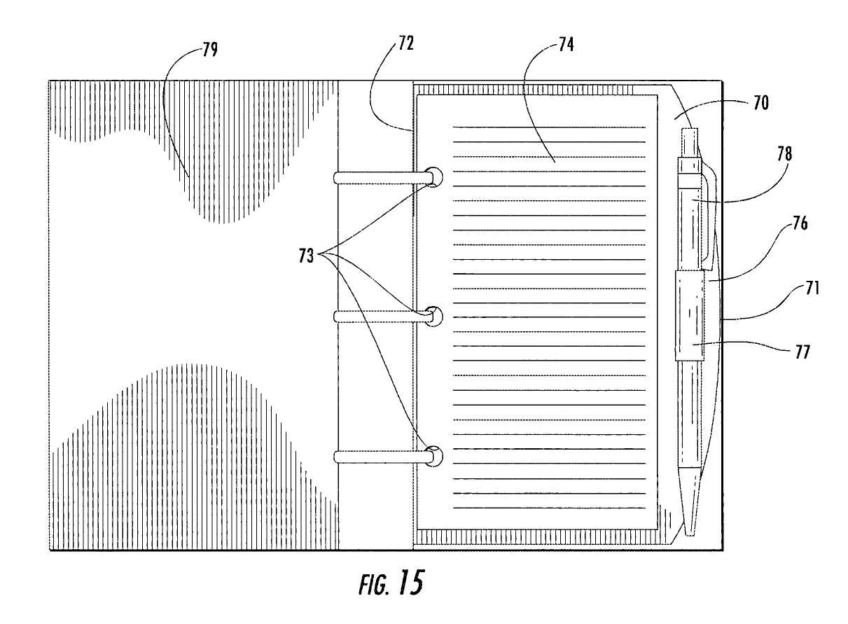

The divider 70 is a sheet having a planar surface with first and second major sides. The divider 70 has a side edge 71 having a convex contour that extends outwardly away from a side edge 72 to which the spiral or three ring binder is connected through the use of a plurality of holes 73. This convex contour causes the width of the divider 70 to be greater than that of a sheet of paper 74, and defines a support 76 upon which a writing instrument holder 77 is mounted (See FIG. 15). A ballpoint pen 78 is shown positioned in the writing instrument holder 77; however, the writing instrument holder 77 may alternatively be used to hold any suitable writing instrument in place on the support 76 of the divider 70. FIG. 14 shows an alternative design where the side edge 71 is a rectangular tab. FIG. 15 shows the divider 70 used in a three ring binder 79.

A notebook, a folio, and a divider with a writing instrument holder has been disclosed. Various details of the invention may be changed without departing from its scope. Furthermore, the foregoing description of the preferred embodiments of the invention and the best mode for practicing the invention are provided for the purpose of illustration only and not for the purpose of limitation.

I claim:

1. A notebook, comprising:
(a) a front cover and a back cover each having a first and second major sides, the back cover having a side edge that extends outwardly beyond a corresponding side edge of the front cover by at least a width of a writing instrument and defining a support for the writing instrument;
(b) a writing instrument holder for maintaining a writing instrument in position on the support; and
(c) connecting means for connecting the front cover and the back cover together.

2. The notebook according to claim 1 and including paper sheets having printed indicia thereon selected from the group consisting of calendar indicia, diary, text, photographs, and blank sheets for note taking.

3. The notebook according to claim 1, wherein the front and back covers are formed from a sheet stock selected from the group consisting of plastic, cardboard, and fiberboard.

4. The notebook according to claim 1, wherein the side edge of the back cover has a convex contour.

5. The notebook according to claim 1, wherein the writing instrument holder comprises a loop formed from a flexible material selected from the group consisting of plastic and elastic for providing adequate expansion to accommodate a writing instrument having a larger diameter than a diameter of the loop.

6. The notebook according to claim 1, wherein the writing instrument holder is attached to the support using sewing stitches that extend through the holder and the back cover for preventing the holder from being pulled or otherwise removed from the back cover.

7. The notebook according to claim 1, wherein the writing instrument holder is integrally-formed in the support of the back cover.

8. The notebook according to claim 1, wherein the connecting means is selected from the group consisting of spiral binding and three ring binding for binding the sheets, the front cover, and the back cover loosely together.

9. A notebook according to claim 1, further comprising a closure tab integrally formed with and extending outwardly from the side edge of the back cover with the writing instrument holder for maintaining the writing instrument in an interior of the closure tab.

10. The notebook according to claim 9, wherein the front cover includes a male fastener and the closure tab includes a female fastener acting in cooperation with each other for maintaining the notebook in a closed position.

11. A folio, comprising:
(a) a single sheet of material folded to form a front cover and a back cover each having first and second major sides, the back cover having a side edge that extends outwardly beyond a corresponding side edge of the front cover by at least a width of a writing instrument and defining a support for the writing instrument;
(b) a writing instrument holder for maintaining a writing instrument in position on the support; and
(c) a closure tab formed with and extending outwardly from the side edge of the back cover.

12. The folio according to claim 11, wherein the front cover includes a male fastener and the closure tab includes a female fastener acting in cooperation with each other for maintaining the notebook in a closed position.

13. The folio according to claim 11, wherein the back cover includes an integrally-formed writing pad holder.

14. The folio according to claim 13, wherein the writing pad holder is attached against an inner surface of the back cover by at least one rivet.

15. The folio according to claim 13, wherein the writing pad holder includes an elongated slot for receiving a writing pad.

16. A divider, comprising
(a) a sheet having a planar surface with first and second major sides, the sheet having a side edge that extends outwardly beyond a corresponding side edge of a sheet of paper by at least a width of a writing instrument and defining a support for the writing instrument;
(b) a writing instrument holder for maintaining the writing instrument in position on the support; and
(c) connecting means for connecting the divider to a notebook.

17. The divider according to claim 16, wherein the sheet is formed from a sheet material selected from the group consisting of plastic, cardboard, and fiberboard.

18. The divider according to claim 16, wherein the writing instrument holder comprises a loop formed from a flexible material selected from the group consisting of plastic and elastic for providing adequate expansion to accommodate a writing instrument having a larger diameter than a diameter of the loop.

19. The divider according to claim 16, wherein the writing instrument holder is attached to the support by a means selected from the group of sewing stitches and integrally-formed with the divider.

20. The divider according to claim 16, wherein the connecting means includes a plurality of holes positioned along a side edge for accepting spiral or three ring binding.
